(19) United States
(12) Patent Application Publication
(10) Pub. No.: US 2011/0216143 A1
(43) Pub. Date: Sep. 8, 2011

(54) LICENSING IDENTIFICATION AND MANAGEMENT SYSTEM AND CODING METHOD OF ANTI-COUNTERFEIT LABEL THEREOF

(75) Inventor: Jung-Bang Wang, New Taipei City (TW)

(73) Assignees: JUNG-BANG WANG, NEW TAIPEI CITY (TW); STOREWELL MEDIA MANUFACTURING LTD., TAOYUAN COUNTY (TW)

(21) Appl. No.: 12/984,054

(22) Filed: Jan. 4, 2011

(30) Foreign Application Priority Data
Mar. 8, 2010 (TW) 99106593

(51) Int. Cl. G06K 19/06; B41J 2/00

(52) U.S. Cl. 347/107; 235/494

(57) ABSTRACT

This invention relates to a licensing identification and management system and a coding method of an anti-counterfeit label. One embodiment discloses utilizing a license code producing device to produce a license key and a royalty key, wherein the license key includes a license number and a license code, and the royalty key includes a royalty number and a royalty code. The method further includes separating and reassembling the license key and the royalty key to generate a bar code by a bar code generating device, and saving the bar code into an audit database. The method also includes utilizing a bar code printing device for generating an anti-counterfeit label according to the bar code and attaching the anti-counterfeit label to a product. Therefore, according to a comparison between that particular bar code and that stored in the audit database the product could be identified as a licensed product.

### BACKGROUND OF THE INVENTION

1. Field of the Invention

The present invention relates to an anti-counterfeit label; in particular, to an anti-counterfeit label having specially coded human readable text (HRT) code and auto data collection (ADC) code.

2. Description of Related Art

To ensure the advancement of the technology, companies generally devote sufficient resource to their corresponding business developments. Unfortunately, their works are often subject to others' exploitation such as unauthorized duplications and adulterations of genuine products with spurious items absent appropriate protection mechanism in place. The rampancy of those activities not only causes tremendous monetary losses worldwide but also even jeopardizes the reputation and the goodwill of the companies making the genuine goods. To minimize the impact associated with the exploitation activities, numerous anti-counterfeit technologies have been developed and comprehensively applied to a variety of merchandises, such as electronic products or computer software and the like.

At the present, a two-dimensional bar code or a registration code is printed or specified on a general product for the purpose of registration or licensing identification. However, while the business may collect required information, control product sales and manage licensing affairs as the result this anti-counterfeit technology may have its own limits including provision of limited information, and difficulty in audit operations. Or, issues like licensing information leakage may even occur because that no method regarding confidentiality or protection is provided in such anti-counterfeit technologies.

More advanced anti-counterfeit technologies combine techniques such as optics, information and electronics and so forth, and even the DNA anti-counterfeit technique or other state-of-art means as well. Although these more advanced anti-counterfeit technologies are able to provide accurate licensing information, expensive machines and apparatus are needed for subsequent audit operations. For audit units, it is hard and impractical to prepare all equipments to verify every advanced anti-counterfeit technology. Contrarily, by using conventional tools, such as bar code scanner, computer or cellular phone, anti-counterfeit technologies according to currently existent two-dimensional bar code or registration number can still nonetheless find their own particular feasibility.

Meanwhile, counterfeit skills also evolve, and the counterfeiter can fake a variety of plausible anti-counterfeit labels, too. It is hence required to develop a new coding technology to be applied to the anti-counterfeit label which is simple, enabled for secret protection and not easily breakable so as to truly impede the counterfeiter's attempts of forgery; furthermore, the new coding technology can be also employed on a various anti-counterfeit means so as to further improve their security and feasibility, thereby getting rid off such an endless trap of technical competition with the counterfeiter.

### SUMMARY OF THE INVENTION

When an applicant intends to manufacture and sell a product, it is almost unavoidable that parts of such product have been patented and the relevant patent protection has not expired. Therefore, it is theoretically necessary for the applicant to become a licensee in order to legally manufacture and distribute the product covered by the patented technologies. The objective of the present invention is to offer a new anti-counterfeit label applicable for a variety of products which can facilitate operations on licensing management and act as a baseline for infringement audits and counterfeit product identifications.

An embodiment according to the present invention proposes a coding method of anti-counterfeit label, comprising: generating a license key category value and a royalty key category value through a license code generating device, generating a license code through the license code generating device, in which the license code consists of a license key and royalty key, and the license key includes a license number and a license code, while the royalty key includes a royalty number and a royalty code, and through a bar code generating device arranging and combining the license number, the royalty number and the royalty key category value to form a human readable text (HRT) code, and arranging and combining the license code, the royalty code and the license key category value to form an auto data collection (ADC) code.

An embodiment according to the present invention proposes a licensing identification and management system. The system includes a license application device, which receives a license application for a product and generates a license request signal, a license code generating device, which receives the license request signal and generates a license code based on the received license request signal, in which the license code consists of a royalty key category value, a license key category value, a license key and a royal key, and the license key includes a license number and a license code, and the royalty key includes a royalty number and a royalty code, a bar code generating device, which receives the license code and accordingly generates a bar code, in which the bar code consists of a human readable text (HRT) code including the license number, the royalty number and the royalty key category value and an auto data collection (ADC) code including the license code, the royalty key and the license key category value, an audit database, which consists of a human readable text (HRT) code database and an auto data collection (ADC) code database, is configured to receive and store the bar code, in which the HRT code is stored in the HRT code database and the ADC code is stored in the ADC code database, and a bar code printing device, which receives the bar code and accordingly generates an anti-counterfeit label.

The aforementioned general summary and following detailed descriptions along with appended diagrams are illustrated for further explaining the means, measures and effects taken by the present invention for achievement of the prescribed objective. Other relevant goals and advantages of the present invention will be also disclosed in the subsequent texts and drawings.

### BRIEF DESCRIPTION OF THE DRAWINGS

FIG. 1 shows a flowchart for the licensing identification and management system according to an embodiment of the present invention;

FIG. 2 shows a system architecture diagram for the licensing identification and management system according to an embodiment of the present invention;

FIG. 3 show a diagram of the anti-counterfeit label according to an embodiment of the present invention; and

FIG. 4 shows a flowchart for an audit process according to an embodiment of the present invention.

### DETAILED DESCRIPTION OF THE PREFERRED EMBODIMENTS

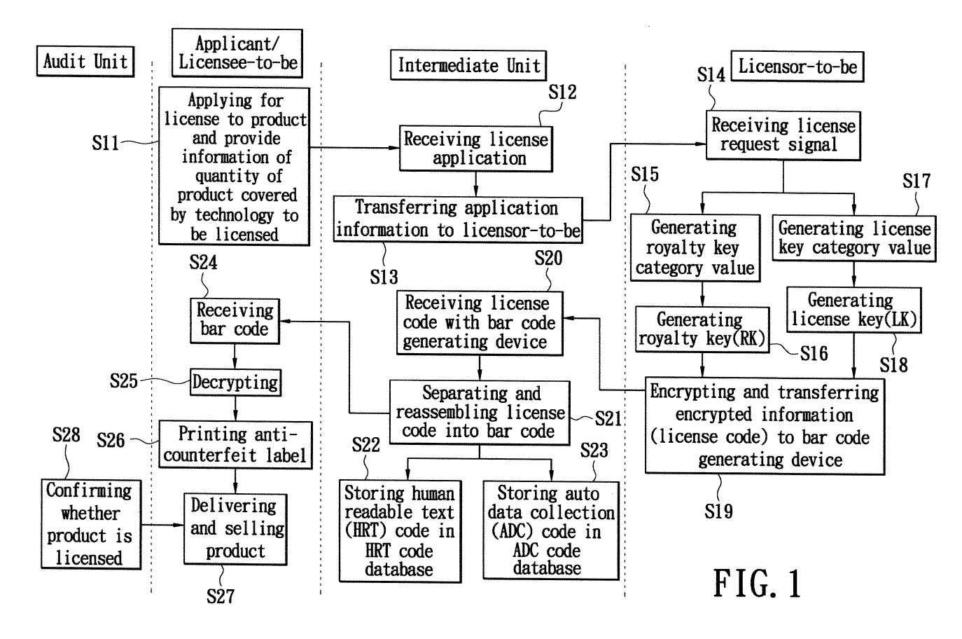

Refer initially to FIG. 1 wherein a flowchart for a licensing identification and management system according to an embodiment of the present invention is shown.

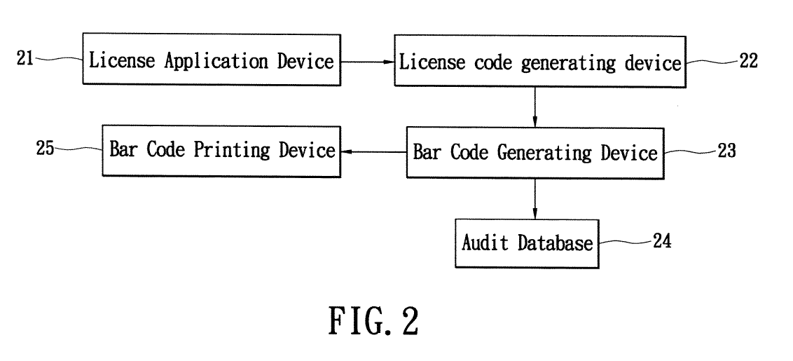

Additionally, a system architecture diagram for the licensing identification and management system according to an embodiment of the present invention is shown in FIG. 2.

As technologies progress, manufacturing processes may become more and more complicated, and thus the manufacturing of one specific product may be associated with numerous patented processes in a variety of technical fields such as production, specification, profile design, and circuitry design. And since several entities may respectively own those patented technologies processes and those entities in the related industries may organize an intermediate unit in charge of licensing management affairs. Accordingly, when an applicant applies for an official product license regarding to a specific product, the applicant may have to submit an application to the intermediate unit. Taking the DVD industry for an example, the aforementioned intermediate unit can be the DVD6C licensing organization which is jointly constituted by Hitachi, Mitsubishi, Samsung, Sanyo, Sharp and so forth, and is for product licensing management for all products related to DVD.

Conjunctively refer to FIGS. 1 and 2, when any entity intends to manufacture and sell a product with patented technologies, the entity theoretically is required or forced to contact with the intermediate unit for patent licensing and provide information such as the product lists covered by the technologies to be licensed and the quantity thereof, as shown in S11 in the flowchart. Upon receiving the application the intermediate unit may transfer the application to the license application device 21 thereof in accordance with the code of the applicant (or licensee-to-be) as well as the information such as the product lists covered by the technologies to be licensed and the quantity of the products in the lists, as shown in S12 and S13. The license application device 21 of the intermediate unit may generate a license request signal based on various product lists and respectively send the license request signals to a license code generating device 22 of each technology owner (or licensor-to-be). And the license code generating device 22 is configured to receive the license request signal, as shown in S14. In one implementation, the license application device 21 is a server or a computer, or even a telephone set or a fax machine, and the license code generating device 22 may be a server, or a computer.

Based on the code of the applicant as well as the product lists and quantity of the products in the lists, the license code generating device 22 respectively generates a royalty key category value and a license code category value, as shown in S15 and S17. The license code generating device 22 further respectively generates a royalty key (RK) and a license key (LK) based on the royalty key category value and the license code category value, respectively, as shown in S16 and S18. The LK consists of a license code (LC) and a license number (LN), and the RK consists of a royalty code (RC) and a royalty number (RN). As such, the license code generating device 22 may be capable of preparing the corresponding royalty payment information in accordance with the acquired RK and LK. The license code generating device 22 may encrypt the royalty key category value, license key category value, the RK, the LK as well as the name and the quantity of the products and transfer the encrypted information to the bar code generating device 23 at the intermediate unit, as shown in S19. The encrypted information transferred collectively is referred as the license code.

Upon receiving the encrypted license code, the bar code generating device 23 at the intermediate unit may performs decryptions on the encrypted license code before approving the license application, as shown in S20. The bar code generating device 23 separates the RK and the LK within the received license code, and is configured to reassemble conjunctively with the name and the quantity of the products, the royalty key category value as well as the license key category value in order to generate the bar code information. The bar code information includes a set of auto data collection (ADC) code and generates a set of human readable texts (HRT) code. The ADC code includes a combination of the LC, the RC and the license key category value, and the HRT code includes a combination of the LN, the RN and the royalty key category value, as shown in S21. The bar code generating device 23 stores the ADC code and the HRT code in an audit database 24 as shown in S22 and S23, so that the ADC code the HRT code may be utilized for subsequent audit operations. It is worth noting that the audit database 24 may include an ADC code database and a HRT code database. Herein the bar code generating device 23 may be a server or a computer, the audit database 24 may be a memory unit in a server or a computer.

Since the ADC code and the HRT code are respectively stored in an ADC code database and a HRT code database, the LC, the RC, the LN and the RN may be stored in the different storage space, minimizing the likelihood of unauthorized access to the LC, the RC, the LN, and the RN all at once. Further, the LC, RC, LN and RN are random codes or sequential numbers which do not include any information in themselves, so no losses may result even the LC, the RC, the LN, or the RN is accessed without authorization.

The bar code generating device 23 encrypts and transfers the bar code information such as the ADC code and the HRT code to a bar code printing device 25, which receives the bar code information as shown in S24. The bar code printing device 25 may receive and decrypt the ADC code and the HRT code through a decryption method previously assigned by the intermediate unit, as shown in S25. The bar code printing device 25 then prints the anti-counterfeit label in accordance with the acquired ADC code and HRT code and the label may be attached onto the products, as shown in S26. Finally, the applicant (or licensee-to-be) may deliver or sell the products with the anti-counterfeit labels attached thereon, as shown in S27. The bar code printing device 25 may be a printer, a bar code machine or a label printer.

As such, the product with the above-mentioned particular label may be identified by means of the product name and quantity on the anti-counterfeit label and therefore that the product is indeed officially licensed and that the content of the product is identical to the content that is licensed could be confirmed, as shown in S28. Similarly, the audit unit or other administrative units can also perform the identification process based on such an anti-counterfeit label thus effectively blocking the counterfeit goods from flowing into the stream of commerce.

Through the aforementioned intermediate unit may help simplify the product licensing process, the possibility of commercial information leakage about the licensor-to-be should not be overlooked when the intermediate unit is responsible for directly negotiating with the applicant. As such, the licensor-to-be may be unwilling to leave their license data at the intermediate unit. Consequently, the license code generating device 22 may be installed at each of the licensors-to-be thereby independently generating the RK and the LK and having the generated RK and LK encrypted and transferred to the intermediate unit. The intermediate unit then separates and reassembles the received RK and LK into the ADC code and the HRT code, and respectively stores them in the ADC code database and the HRT code database of the audit database 24.

Hence, the data associated with each licensor-to-be that is stored in the license database includes the royalty key category value, the license key category value, the RK and the LK. Since the LC, the RC, the LN and the RN are already saved in different databases and merely sequential numbers or random numbers, and the royalty key category value and license key category value are generated by corresponding formulas, the corresponding product type and quantity thereof may not be obtained as the result, preventing the commercial information of each licensor-to-be from being accessed by unauthorized parties.

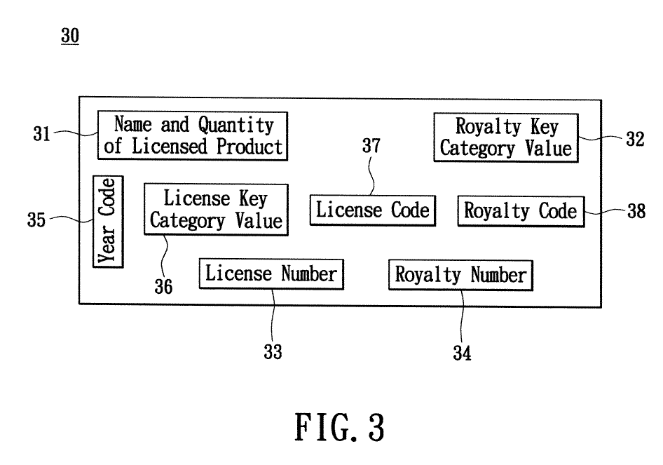

FIG. 3 shows a diagram of the anti-counterfeit label according to an embodiment of the present invention.

The anti-counterfeit label 30 according to one embodiment of the present invention consists of a label indicating the licensed product name and quantity 31, as well as an HRT code set and an ADC code set. The HRT code may be a combination of numbers and the ADC code may be a two-dimensional bar code. The HRT code includes a royalty key category value 32, a license number (LN) 33 and a royalty number (RN) 34, and the ADC code includes a year code 35, a license key category value 36, a license code (LC) 37 and a royalty code (RC) 38. The HRT code may be an 18-digit code, consisting of the 6-digit royalty key category 32, the 6-digit LN 33 and the 6-digit. The ADC code may be a combination of a 15-digit number and characters, consisting of the 2-digit year code 35, the 2-digit license key category value 36, the LC 37 including 5-digit number and characters, and the RC 38 including 6-digit number and characters. The number may be selected from a group consisting of 0 to 9, and the character may include numbers from 0 to 9 and English cap-sensitive alphabets from A to Z.

The licensed product name and quantity 31 specified on the anti-counterfeit label allows for direct verification of whether the product contents and quantity are accurate. The HRT code may be inputted through a manual input device, such as a computer, a PDA or a cellular phone, and the input of the HRT code may be confirmed by having the manual input device connected to the HRT code database at the intermediate unit. The ADC code allows for a bar code scanner to scan and the result of the scanning may be linked to the ADC code database at the intermediate unit through an electronic device like a computer, a PDA or a cellular phone so that the ADC code could be confirmed. In one implementation, the 18 digits in the HRT code are numbers, thus facilitating manual input operations.

Therefore, royalty key category value may serve as an index for the HRT code database. The year code and the license key category value may also serve as indices for the ADC code database.

The following Table 1 illustrates the coding method according to an embodiment of the present invention.

Initially, each applicant (or licensee-to-be) has at least a first code and a second code. In one implementation, the first code is a 3-digit number and the second code is a 3-digit number as well. As such, the first code and the second code may range from 100 to 999. The royalty indicator may vary based on different product types or applicants, each of which may be represented in a 2-digit number. The license quantity depends on the quantity of the products provided by the applicant (or licensee-to-be). Therefore, the royalty key category value may be the sum of the first code and the second code. In this way, the total amount of royalty may be calculated on basis of the royalty indicator and the license quantity. And an adjustment parameter of any number may be provided to serve as a security number.

The aforementioned first code, second code, royalty indicator, license quantity, license key category value and an adjustment parameter may serve as the basis for the determination of a unique royalty key category value.

Therefore, with the method illustrated as above, the particular license key category value and royalty key category value associated with every product license application submitted by the applicant could be further determined.

Subsequently, with the license key category value and the royalty key category value, a royalty key (RK) consisting of a royalty number (RN) 34 and a royalty code (RC) 38 as well as a license key (LK) consisting of a license number (LN) 33 and a license code (LC) 37 may be determined. In addition, the RK, the LK, the license key category value, the royalty key category value and corresponding licensed product name and quantity 31 are transferred to the bar code generating device at the intermediate unit. The bar code generating device at the intermediate unit adds the year code to the RK, the LK, the license key category value, the royalty key category value, and the licensed product name and quantity before the transmission thereof to the applicant/licensee-to-be. As such, the anti-counterfeit label 30 may be prepared. It is worth noting that the year code may be also directly generated by the license code generating device. The bar code generating device at the intermediate unit separates and reassembles the RK and the LK, before storing the royalty key category value, the RN 34 and the LN 33 in the HRT code database and the year code 35, the license key category value, the RC 38 and the LC 37 in the ADC code database.

That the ADC code and the HRT code of the present invention are different in length and are associated with different characters significantly reduces the possibility of counterfeit of the anti-counterfeit label with the ADC code and the HRT code. Besides, since the ADC code and the HRT code of the present invention are both calculated through predetermined formulas/equations, they are independent with respect to each other and, as the calculation formulas are generally unknown to any unauthorized party, the information such as the first code, second code as well as the royalty indicator and the license quantity may not be accessed.

TABLE 1
Coding Method according to Embodiment of Present Invention

| Code | A | B | C | D | E | F | |
|---|---|---|---|---|---|---|---|
| Name | First | Second | Royalty | License | License Key | Adjustment | Royalty Key |
| | Code | Code | Indicator | Quantity | Category | Parameter | Category |
| | | | | | Value | | Value |
| Coding | 100~999 | 000~999 | 10~99 | 1~999 | Adding | Arbitrarily | |
| | | | | | individual | Defined | |
| | | | | | digit numbers | | |
| | | | | | in A and B | | |

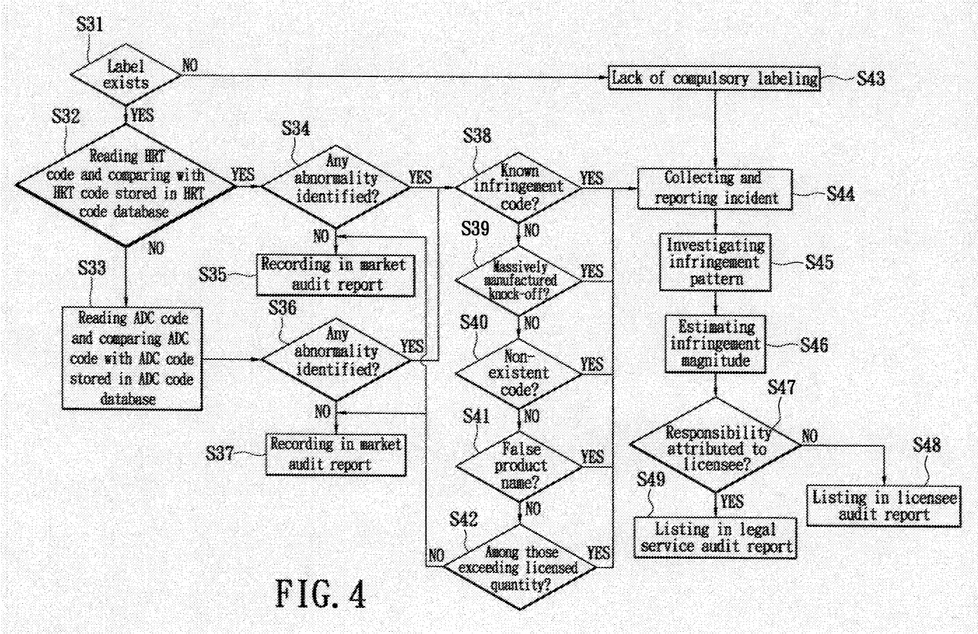

FIG. 4 shows a flowchart for an audit process according to an embodiment of the present invention.

When the audit unit initiates a license audit process for the product, whether the anti-counterfeit label 30 is present on the product is determined, as shown in S31. As the anti-counterfeit label should be conspicuously presented on the product per the license contract, it may be safe to assume that the product without the presence of the anti-counterfeit label 30 presented may be considered either a knock-off or a product in lack of the labeling process, as shown in S43. When the product is the knock-off or in lack of the labeling process, an incident of the knock-off or the lack of the labeling may be collected and reported, as shown in S44. When the product is with the anti-counterfeit label 30, the may confirm whether the product name and quantity thereof match the licensed product name and quantity 31, respectively. More specifically, the audit unit may read the HRT code and the ADC code specified on the anti-counterfeit label 30 before querying whether the HRT code and the ADC code on the product match the counterparts stored in the HRT code database or the ADC code database by linking to the audit database 24 at the intermediate unit, as shown in S32 and S33. S34 and S35 are for identifying any abnormality (e.g., the HRT code read from the product is not in match with the HRT code stored in the HRT code database). In case that no abnormality is identified, the auditing operation may be recorded in a market audit report, as shown in S35 and S37. Otherwise, suppose no corresponding HRT code or ADC code is found in the HRT code database or the ADC code database at the audit database 24, the product examined may fall into the category of the knock-off product.

The method may compare the HRT code or ADC code marked on the product with known infringement codes (S38). When the HRT code or the ADC code matches the known infringement code, that particular product may be one of massively manufactured counterfeit items (S39) and subsequent collection and report procedures for the incident (e.g., massively manufactured counterfeit item found) may be enabled (S44). When the HRT code/ADC code is different from the known infringement codes (S40), the product with the HRT code/ADC code may be a new infringement product, and that particular HRT code or the ADC code may be archived as one of the known infringement code and saved in the audit database 24. When the determinations in S39 and S40 are positive, the method may proceed to S44 for further processing including reporting the incident and launching corresponding investigation (S45) for determining whether the product with the same HRT code or ADC code has been massively manufactured, the HRT code or the ADC code is a non-existent number, the product is with a false product name thus resulting in mismatches in license code and product name (S41), or alternatively the product is among those that have been exceeding the licensed quantity (S42). It is also worth noting that when the determinations in S41 and S42 are positive, the method may proceed to S44 and S45 as well.

In S46, the method according to one embodiment of the present invention may estimate the magnitude of the infringement. In one implementation, the estimation of the magnitude of the infringement may be based on the information provided in S45. The method may further trace the responsibility in S47 to determine whether the licensee should be responsible for the infringement. The concluded audit information is listed in a legal service audit report or a licensee audit report, as shown in S48 and S49. Herein the legal service audit report may include asking for sequestration of counterfeit items and fines, and the licensee audit report may recite the licensing condition on which actions of such as forfeiture or breach of contract or royalty adjustment, or even cancellation of license may be based.

Table 2 illustrates comparisons between the anti-counterfeit label according to an embodiment of the present invention and other common labels.

For comparing the anti-counterfeit label 30 according to the present invention with other common anti-counterfeit labels in the market, such common anti-counterfeit labels may exemplarily include VEEZA license project from Philips, TUV anti-counterfeit label proposed by Rheinland Group (Germany), and other conventional two-dimensional bar codes. The conventional anti-counterfeit labels do not enable infringement pattern analyses, and the possibility of license database leakage also indeed exists. However, the anti-counterfeit label according to the present invention features high confidentiality, low construction cost, application of identical coding methods on different products in the same industry, superior compatibility, provision of various and simple audit input approaches along with different HRT code and ADC code.

TABLE 2
Comparisons between Anti-counterfeit Label according to Present
Invention and Other Common Labels

| | | | | Two- |
|---|---|---|---|---|
| | Present | | | Dimensional |
| Item | Invention | VEEZA | TÜV | Bar Code |
| HRT Code Audit | YES | YES | YES | Not Sure |
| Function | | | | |
| ADC Code Audit | YES | YES | NO | YES |
| Function | | | | |
| Batch Audit Function | YES | YES | NO | YES |
| Product | YES | NO | YES | YES |
| Name/Quantity Audit | | | | |
| Function | | | | |
| Infringement Pattern | YES | NO | NO | NO |
| Analysis Function | | | | |
| Royalty Management | YES | YES | Not Sure | Not Sure |
| Function | | | | |
| Anti-counterfeit | YES | NO | YES | YES |
| Function | | | | |
| License Data | YES | Open | Open | Open |
| Confidentiality | | | | |
| Price of Label | Low | High | Moderate | Moderate |
| Price of Automatic | Bar Code | Bar | Cellular | High |
| Reader | Scanner | Code | Phone | |
| | | Scanner | | |
| Number of Stored | Least | Less | Less | Most |
| Characters | | | | |
| Cellular Phone Audit | YES | NO | YES | Not Sure |
| Function | | | | |
| Convenience in | 0~9 | 0~Z | 0~Z | 0~Z |
| Human Input | | | | |
| Equivalence in ADC | NO | YES | YES | YES |
| Code and HRT Code | | | | |
| Confidence of | YES | NO | NO | NO |
| Licensor-to-be | | | | |
| Compatibility in | Good | Good | Good | Poor |
| Different Product | | | | |
| Codes | | | | |

The illustrations set forth hereinbefore merely indicate the detailed descriptions for the preferred embodiments of the present invention and the append drawings thereof, but the characteristics of the present invention are by no means restricted thereto. All changes, alternations, or modifications conveniently considered by those skilled ones in the art are deemed to be encompassed within the scope of the present invention delineated by the following claims.

What is claimed is:

1. A coding method of anti-counterfeit label, comprising:
generating a license key category value and a royalty key category value through a license code generating device;
generating a license code through the license code generating device, in which the license code consists of a license key and royalty key, and the license key includes a license number and a license code, while the royalty key includes a royalty number and a royalty code; and
arranging and combining, through a bar code generating device, the license number, the royalty number and the royalty key category value to generate a human readable text (HRT) code, and arranging and combining the license code, the royalty code and the license key category value to generate an auto data collection (ADC) code.

2. The method according to claim 1, wherein the license key category value is generated based on a first code or a second code, and the royalty key category value is generated based on at least one of the first code, the second code, a royalty indicator, a license quantity and the license key category value, in which the license number, the royalty number, the license code and the royalty code are randomly generated or sequential numbers.

3. The method according to claim 1, wherein the anti-counterfeit label further comprises a licensed product name and quantity, and the ADC code further consists of a year code.

4. The method according to claim 1, wherein the HRT code is stored in a HRT code database, the ADC code is stored in an ADC code database, and an audit database consists of the HRT code database and the ADC code database in which the HRT code is a combination of numbers and the ADC code is a combination of numbers and characters.

5. The method according to claim 1, wherein the license code generating device and the bar code generating device respectively are controlled by a licensor-to-be and an intermediate unit, in which the licensor-to-be generates the license code by the license code generating device and the intermediate unit generates the HRT code and the ADC code through the bar code generating device.

6. A licensing identification and management system, comprising:
a license application device, which receives a license application for a product and generates a license request signal;
a license code generating device, which receives the license request signal and generates a license code based on the received license request signal, in which the license code consists of a royalty key category value, a license key category value, a license key and a royal key, and the license key includes a license number and a license code, and the royalty key includes a royalty number and a royalty code;
a bar code generating device, which receives the license code and accordingly generates a bar code, in which the bar code consists of a human readable text (HRT) code and an auto data collection (ADC) code, wherein the HRT code includes the license number, the royalty number and the royalty key category value, and the ADC code includes the license code, the royalty key and the license key category value;
an audit database, which consists of a human readable text (HRT) code database and an auto data collection (ADC) code database, and receives and stores the bar code, in which the HRT code is stored in the HRT code database and the ADC code is stored in the ADC code database; and
a bar code printing device, which receives the bar code and accordingly generates an anti-counterfeit label.

7. The system according to claim 6, wherein the license number, the royalty number, the license code and the royalty code are randomly generated or sequential numbers.

8. The system according to claim 7, wherein the HRT code is a combination of numbers and the ADC code is a combination of numbers and characters.

9. The system according to claim 7, wherein the license key category value is generated based on a first code or a second code, and the royalty key category value is generated based on at least one of the first code, the second code, a royalty indicator, a license quantity and the license key category value.

10. The system according to claim 7, wherein the anti-counterfeit label further comprises a licensed product name and quantity, and the ADC code further consists of a year code.
